(19) United States
(12) Patent Application Publication
(10) Pub. No.: US 2008/0218481 A1
(43) Pub. Date: Sep. 11, 2008

(54) APPARATUS HAVING LIQUID CRYSTAL TOUCH PANEL AND OPERATION KEYS

(76) Inventors: Tatsuya WATABE, Nara (JP); Tomoki Tanaka, Kanagawa (JP); Tadashi Nagaso, Nara (JP); Rika Ichiu, Nara (JP); Masaki Higashiura, Nara (JP); Katsuya Kitayama, Nara (JP); Yusuke Nagai, Nara (JP); Naofumi Ueda, Kyoto (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/040,991

(22) Filed: Mar. 3, 2008

(30) Foreign Application Priority Data
Mar. 6, 2007 (JP) 2007-055919

(51) Int. Cl. G09G 5/00

(52) U.S. Cl. 345/168

(57) ABSTRACT

In one embodiment, the present invention provides an apparatus having a liquid crystal touch panel and operation keys, the liquid crystal touch panel displaying display buttons, and the operation keys being outside of the liquid crystal touch panel, and the display buttons of the liquid crystal touch panel and the operation keys being operated together, in which the liquid crystal touch panel, on a screen, displays display contents that differ from each other such that the display contents can be viewed from two directions that differ from each other, and such that display buttons on the screen of the liquid crystal touch panel when viewed from one direction and operation keys used with the display buttons are near each other, the display buttons are disposed on the screen, or the operation keys are disposed relative to the liquid crystal touch panel.

### BACKGROUND OF THE INVENTION

This application claims priority under 35 U.S.C. §119(a) on Japanese Patent Application No. 2007-055919 filed in Japan on Mar. 6, 2007, the entire contents of which are herein incorporated by reference.

The present invention relates to an apparatus having a liquid crystal touch panel and operation keys, the liquid crystal touch panel displaying display buttons, and the operation keys being outside of the liquid crystal touch panel, and the display buttons of the liquid crystal touch panel and the operation keys being operated together.

In this type of apparatus, a liquid crystal touch panel is used in which a transparent touch panel has been overlaid on the screen of a liquid crystal display apparatus, display buttons are displayed on the screen, the touch panel detects touching of a display button on the screen, and this touching of the display button is deemed to be an input operation. Also, depending on the display contents of the screen, there may be an instance when a display button is not displayed on the screen, so with respect to a high frequency input operation, an ordinary operation key that can be operated at any time is separately provided.

For example, in an image forming apparatus such as a copier, it is possible to input settings for recording paper size, image magnification ratio, printing darkness, and the like, and various input operations are possible. Thus, every time these settings are input, only necessary display buttons are switched and displayed on the screen, so input operations do not become complicated. Also, because the frequency of input operations is high for a numeric keypad, a start key, and the like, these are provided as ordinary operation keys.

On the other hand, with the technology described in JP 2005-78076A (paragraphs 0002 to 0006, FIGS. 1 and 2), a so-called parallax barrier layer is overlaid on the screen of a liquid crystal display apparatus, and when the screen is viewed from two directions that differ from each other, on the screen it is possible to view respective display contents that differ from each other. For example, when this liquid crystal display apparatus is mounted in a vehicle, and the screen is viewed from the driver seat side, it is possible to view a roadmap on the screen, and when the screen is viewed from the passenger seat side at the same time, it is possible to view a movie on the screen.

Also, with the technology described in JP 2005-284592A (paragraphs 0005 to 0011 and 0031 to 0033, FIGS. 3, 4, and 11), as in JP 2005-78076A, when the screen is viewed from two directions that differ from each other, on the screen it is possible to view respective display contents that differ from each other, and in addition, a touch panel is overlaid on this screen, and via the touch panel, it is possible to perform an input operation for any of the display contents viewed from the two directions.

If an apparatus of the sort described in JP 2005-284592A is applied, a plurality of users, while simultaneously viewing the respective display contents on a screen, can perform respective input operations via the touch panel.

For example, in an image forming apparatus (multifunction device) having a plurality of functions such as a copy function, a facsimile function, a printer function, and a scanner function, copying, faxing, and the like can be performed simultaneously, so while two users are respectively viewing display contents related to copying and display contents related to faxing simultaneously on a screen, it is possible to respectively perform an input operation related to copying and an input operation related to faxing via the touch panel.

However, in the above multifunction device, because there are several functions, there are also many types of ordinary operation keys, so there may be instances when an input operation is performed using both a display button on the screen and an ordinary operation key.

Furthermore, when an apparatus as described in JP 2005-284592A has been applied, two users simultaneously perform an input operation, so the positional relationship of the display buttons on the screen and the ordinary operation keys has a great effect on operability for both users. For example, assuming that a display button or an operation key that one of the users should operate is closer to the other user than the one user, it becomes difficult for the one user to perform the input operation, and the input operation of the one user also has an adverse effect on input operations of the other user.

In JP 2005-284592A, it is not assumed that a display button on the screen and an ordinary operation key will be used together in this manner, and so an arrangement of the display buttons on the screen and the operation keys that has good operability for either of the two users is not proposed.

### SUMMARY OF THE INVENTION

The present invention was made in view of the above conventional problems, and it is an object thereof to provide an apparatus having a liquid crystal touch panel and operation keys, in which when respective input operations are performed via the touch panel while a plurality of users are simultaneously viewing respective display contents in a screen, and along with that an input operation of the operation keys is performed, usability is good for the respective users.

In order to address the above problems, the present invention provides an apparatus having a liquid crystal touch panel and operation keys, the liquid crystal touch panel displaying display buttons, and the operation keys being outside of the liquid crystal touch panel, and the display buttons of the liquid crystal touch panel and the operation keys being operated together, in which the liquid crystal touch panel, on a screen, displays display contents that differ from each other such that the display contents can be viewed from two directions that differ from each other, and such that display buttons on the screen of the liquid crystal touch panel when viewed from one direction and operation keys used with the display buttons are near each other, the display buttons are disposed on the screen, or the operation keys are disposed relative to the liquid crystal touch panel.

Also, the display buttons are disposed on one side of the screen, such that display buttons on the screen of the liquid crystal touch panel when viewed from one direction and operation keys used with the display button are near each other, and display contents that differ from the display buttons are displayed on the other side of the screen.

Further, the apparatus having a liquid crystal touch panel and operation keys is applied to an image forming apparatus having a plurality of functions, and the display buttons are disposed in one half of the screen, such that display buttons on the screen of the liquid crystal touch panel when viewed from one direction and operation keys used with the display buttons are near each other, other display buttons are disposed in the other half of the screen of the liquid crystal touch panel when viewed from the other direction, and the display buttons in the one half and the other display buttons in the other half of the screen of the liquid crystal touch panel are related to functions that differ from each other.

According to the present invention configured in this manner, the liquid crystal touch panel, on a screen, displays display contents that differ from each other such that the display contents can be viewed from two directions that differ from each other, so without increasing the number of liquid crystal touch panels, simultaneous use by a plurality of users is possible. Moreover, due to operation keys being provided near the liquid crystal touch panel, so that the display buttons displayed in the liquid crystal touch panel and the operation keys are disposed gathered together, operability of both the operation keys and the display buttons improves.

Also, because the display buttons are disposed on one side of the screen, and display contents that differ from the display buttons are displayed on the other side of the screen, by displaying information other than the display buttons, such as status of the apparatus, which has no effect on operation or settings of the apparatus, it is possible to display many messages to a user, so operability of the apparatus improves.

Also, the apparatus having a liquid crystal touch panel and operation keys is applied to an image forming apparatus having a plurality of functions, in which display buttons are disposed in one half of the screen of the liquid crystal touch panel when viewed from one direction, other display buttons are disposed in the other half of the screen of the liquid crystal touch panel when viewed from the other direction, and these display buttons are provided relating to functions that differ from each other. For example, various operation keys such as a numeric keypad are disposed on the right side of the liquid crystal touch panel. In this case, a user on the right side who uses a copy function uses both various operation keys on the right side of the liquid crystal touch panel and display buttons in the screen of the liquid crystal touch panel, so it is preferable that the display buttons are disposed in the right side half of the screen of the liquid crystal touch panel. Conversely, it is preferable that a user on the left side operates display buttons in the left side half of the screen. Thus, operation of one user does not interfere with operation of the other user, so operation is easy for both users.

### BRIEF DESCRIPTION OF THE DRAWINGS

FIG. 1 is a perspective view that shows an image forming apparatus in which an embodiment of an apparatus according to the present invention has been applied.

FIG. 2 is a block diagram that schematically shows the configuration of the image forming apparatus in FIG. 1.

FIG. 3 shows an operation panel of the image forming apparatus in FIG. 1.

FIG. 4 is a cross-sectional diagram that shows a liquid crystal touch panel in the operation panel in FIG. 3.

FIGS. 5A and 5B show display characteristics of the liquid crystal touch panel in FIG. 4.

FIG. 6 shows a screen when the liquid crystal touch panel is viewed from the right side, and shows an initial screen displayed when a copy key of the operation panel has been pressed.

FIG. 7 shows a screen following the screen in FIG. 6, displayed when an original has been placed in an original paper transport unit.

FIG. 8 shows a screen following the screen in FIG. 7, displayed when an “output” display button has been pressed.

FIG. 9 shows a screen following the screen in FIG. 8, displayed when a “middle staple” display button has been pressed.

FIG. 10 shows a screen following the screen in FIG. 6, displayed when a “special function” display button has been pressed.

FIG. 11 shows a screen following the screen in FIG. 6, displayed when a “duplex copy” display button has been pressed.

FIG. 12 shows a screen following the screen in FIG. 6, displayed when a “copy darkness” display button has been pressed.

FIG. 13 shows a screen following the screen in FIG. 6, displayed when a “paper” display button has been pressed.

FIG. 14 shows a screen following the screen in FIG. 6, displayed when a “magnification” display button has been pressed.

FIG. 15 shows a screen when the liquid crystal touch panel is viewed from the left, and shows the progress status of “print jobs”.

FIG. 16 shows a screen when the liquid crystal touch panel is viewed from the left, and shows the progress status of “e-mail jobs”.

FIG. 17 shows a screen when the liquid crystal touch panel is viewed from the left, and shows the progress status of “(sending) facsimile jobs”.

FIG. 18 shows a screen when the liquid crystal touch panel is viewed from the left, and shows the progress status of “(receiving) facsimile jobs”.

FIG. 19 shows a screen when the liquid crystal touch panel is viewed from the left, and shows a state in which a facsimile/image send key has been pressed.

FIG. 20 shows the positional relationship of display buttons in a state in which the screen in FIG. 6 is displayed to a user on the right side, and the screen shown in FIG. 16 is displayed to a user on the left side.

FIG. 21 shows the positional relationship of display buttons in a state in which the screen in FIG. 14 is displayed to a user on the right side, and the screen shown in FIG. 19 is displayed to a user on the left side.

### DESCRIPTION OF THE PREFERRED EMBODIMENTS

Hereinafter, embodiments of the present invention will be described in detail with reference to the accompanying drawings.

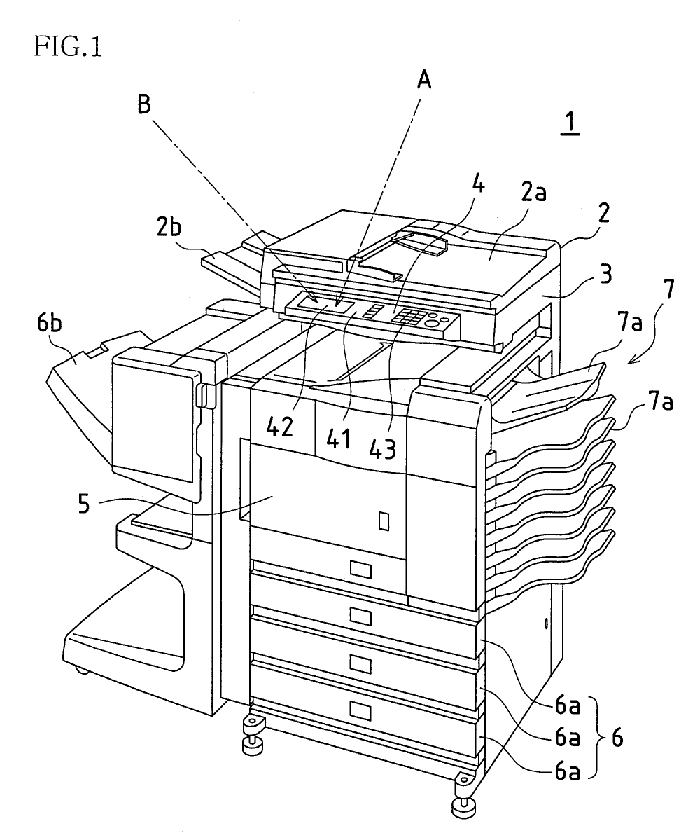

FIG. 1 is a perspective view that shows an image forming apparatus in which an embodiment of an apparatus according to the present invention has been applied. This image forming apparatus 1 is a multifunction device that has a copy function, facsimile function, printer function, scanner function, and a document filing function, and is provided with, for example, an original paper transport unit (automatic document feeder (ADF)) 2, an image reading unit 3, an operation unit 4, provided in a front side wall of the image reading unit 3, an image forming unit 5, a media supply unit 6, and a discharge unit 7.

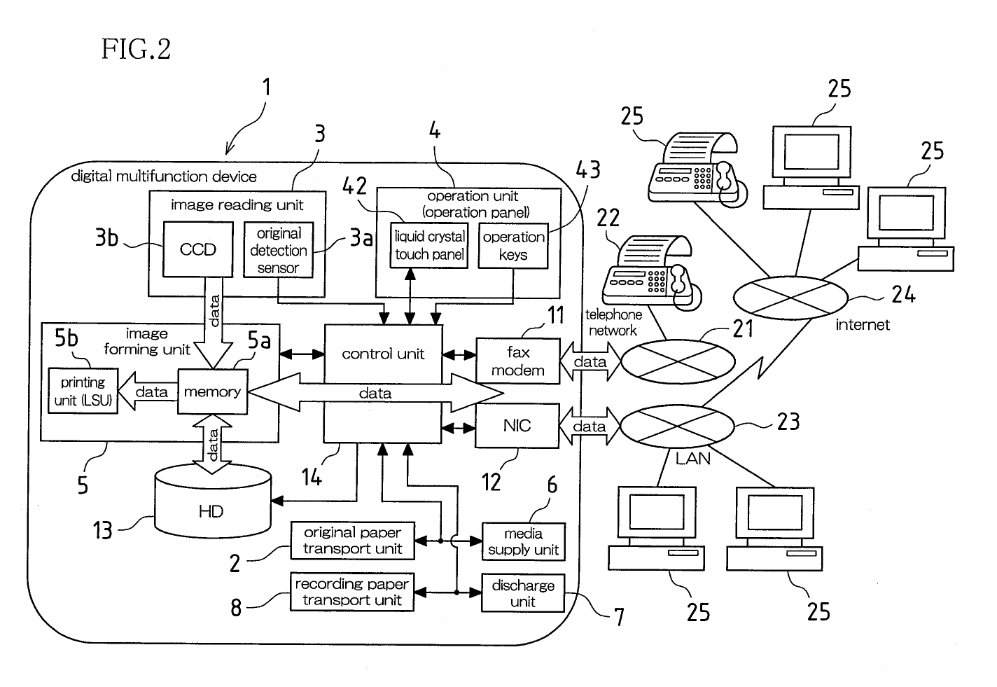

FIG. 2 is a block diagram that schematically shows the configuration of the image forming apparatus in FIG. 1. In addition to the aforementioned original paper transport unit 2, image reading unit 3, operation unit 4, image forming unit 5, media supply unit 6, and discharge unit 7, the image forming apparatus 1 is also provided with a recording paper transport unit 8 that transports recording paper from the media supply unit 6 to the discharge unit 7 via the image forming unit 5, and is furthermore provided with a facsimile modem 11 for performing facsimile communications, an interface 12 for sending/receiving image data to/from an external terminal, a hard disk apparatus 13 that stores image data or the like, and a control unit 14 that controls the entire image forming apparatus 1.

Here, the overall operation of the image forming apparatus 1 will be described with reference to FIGS. 1 and 2, separately describing the copy function, the facsimile function, the printer function, the scanner function, and the document filing function.

Copy Function

When the copy function is selected by an input operation of the operation unit 4, and furthermore settings are input for print conditions such as recording paper size, image magnification ratio, and print darkness, a copy request and print conditions are instructed via the control unit 14 to the original paper transport unit 2, the image reading unit 3, the operation unit 4, the image forming unit 5, the media supply unit 6, the discharge unit 7, and the like, and thus the copy operation is started.

When an original is placed in an original placement tray 2a, the original paper transport unit 2 draws out the original from the tray 2a, and transports the original on a glass platen of the image reading unit 3 to an original discharge tray 2b.

The image reading unit 3 includes an original detection sensor 3a, a CCD (Charge Coupled Device) 3b, an optical scanning unit (not shown) that illuminates an original and forms an image on a light-receiving face of the CCD 3b, and the like. When an original is transported on the glass platen by the original paper transport unit 2, an original image is read by an optical scanning system and the CCD 3b. The optical unit is provided with, for example, a light source that illuminates an original, a plurality of reflecting mirrors that guide reflected light from the original to the CCD 3b, an imaging lens that forms an image of the original on the light-receiving face of the CCD 3b, and a scanning drive system that moves the light source, the reflecting mirrors, and the like.

Also, a configuration is adopted such that it is possible to vertically open/close the original paper transport unit 2 by pivoting at the rear face side of the original paper transport unit 2, and by opening the original paper transport unit 2, it is possible to place an original on the glass platen of the image reading unit 3. At this time as well, the image reading unit 3 reads an original image via the glass platen using the optical scanning unit and the CCD 3b.

Image data that expresses the original image is output from the CCD 3b, and this image data is output to the image forming unit 5.

The image forming unit 5 is provided with a page memory 5a and a printing unit 5b configured from an LSU (Laser Scanning Unit) or the like, and in the image forming unit 5, image data is temporarily stored in the memory 5a, compressed and then transferred to and stored on a hard disk apparatus 13, and furthermore the image data is read out from the hard disk apparatus 13, decompressed and then output to the printing unit 5b. The printing unit 5b records the image expressed by the image data to recording paper. For example, the printing unit 5b performs image recording by an electrophotographic method. In the printing unit 5b, a photosensitive body is exposed to light by the LSU to form an electrostatic latent image on the photosensitive body, the electrostatic latent image on the photosensitive body is developed to form a visible image on the photosensitive body, the visible image is transferred from the photosensitive body to recording paper, and the visible image is fixed on the recording paper.

When image recording to recording paper is performed by the image forming unit 5, the recording paper transport unit 8 receives the recording paper from the media supply unit 6, transports the recording paper to the image forming unit 5, and transports the recording paper on which an image has been recorded with the image forming unit 5 to the discharge unit 7, thus discharging the recording paper.

The media supply unit 6 includes paper feed cassettes 6a at a plurality of levels, and a manual feed tray 6b. Recording paper is drawn out sheet by sheet from a paper feed cassette 6a or the manual feed tray 6b, and then transferred to the recording paper transport unit 8.

The discharge unit 7 includes discharge trays 7a at a plurality of levels. Recording paper to which image recording has been performed by the image forming unit 5 is received from the recording paper transport unit 8, and this recording paper is discharged to any of the discharge trays 7a. Also, in the discharge unit 7, a plurality of sheets of recording paper are discharged to the discharge trays 7a in a sorted manner, and punch processing and staple processing are performed on the sheets of recording paper. For example, when creating a plurality of copies of prints, each sheet of recording paper is sorted and discharged to each discharge tray 7a such that prints are allocated to each discharge tray 7a copy by copy. Further, prints are created by performing, for each discharge tray 7a, punch processing and staple processing on the sheets of recording paper on that discharge tray 7a.

Facsimile Function

When facsimile sending is selected by an input operation of the operation unit 4, and furthermore settings for address data or the like have been input, via the control unit 14, a facsimile send request and address data are instructed to the original paper transport unit 2, the image reading unit 3, the image forming unit 5, the facsimile modem 11, and the like, and a facsimile send operation is started.

In the original paper transport unit 2, when an original is placed in the original placement tray 2a, this original is drawn out from the tray 2a, and transported on the glass platen of the image reading unit 3 to the original discharge tray 2b.

The image reading unit 3 reads an original image via the glass platen, and outputs image data that expresses the original image to the image forming unit 5.

In the image forming unit 5, image data is temporarily saved in the memory 5a, and after compression, the image data is transferred to and saved on the hard disk apparatus 13. Then, the image forming unit 5, at the timing of facsimile sending by the facsimile modem 11, reads the image data from the hard disk apparatus 13, decompresses that data, and outputs the data to the facsimile modem 11.

The facsimile modem 11 calls an external terminal apparatus 22 via a telephone network 21, and when the external terminal apparatus 22 responds, via the image forming unit 5, the image data is input from the hard disk apparatus 13, encoded, and then sent to the external terminal apparatus 22 via the telephone network 21. The external terminal apparatus 22 is, for example, a facsimile apparatus, and when receiving image data, the external terminal apparatus 22 decodes the image data, stores the image data in a memory, and prints an image on recording paper.

At the time of facsimile receiving, the facsimile modem 11 performs an operation of responding to a call from the external terminal apparatus 22, the image data from the external terminal apparatus 22 is received by the facsimile modem 11 and decoded, and the control unit 14 is notified of receiving of image data from the facsimile modem 11. The control unit 14 instructs storage or printing of the image data to the image forming unit 5, the media supply unit 6, the discharge unit 7, and the like.

In the image forming unit 5, image data is received from the facsimile modem 11 and then temporarily saved in the memory 5a, and after compression, the image data is transferred to and saved on the hard disk apparatus 13, and further, the image data is read from the hard disk apparatus 13, decompressed, and output to the printing unit 5b. The printing unit 5b records an image expressed by the image data to recording paper. The recording paper transport unit 8 receives recording paper from the media supply unit 6, transports the recording paper to the image forming unit 5, and transports recording paper to which image recording has been performed by the image forming unit 5 to the discharge unit 7, thus discharging the recording paper.

Printer Function

When image data is sent and received, via a LAN 23 or an Internet 24, from an external terminal apparatus 25 such as a personal computer or a facsimile apparatus to the image forming apparatus 1, image data from the external terminal apparatus 25 is received by the interface 12, and the control unit 14 is notified of receiving of the image data from the interface 12. The control unit 14 instructs storage or printing of the image data to the image forming unit 5, the media supply unit 6, the discharge unit 7, and the like.

In the image forming unit 5, image data is input from the interface 12 and then temporarily saved in the memory 5a, and after compression, the image data is transferred to and saved on the hard disk apparatus 13, and further, the image data is read from the hard disk apparatus 13, decompressed, and output to the printing unit 5b. The printing unit 5b records an image expressed by the image data to recording paper.

Also, when printing of image data in the hard disk apparatus 13 has been instructed by an input operation of the operation unit 4, image data is read from the hard disk apparatus 13 by the image forming unit 5 and decompressed, and an image is recorded to recording paper by the printing portion 5b.

Scanner Function

When the scanner function is selected by an input operation of the operation unit 4, and furthermore settings for address data or the like are input, via the control unit 14, a scanner request and address data are instructed to the original paper transport unit 2, the image reading unit 3, the image forming unit 5, the interface 12, and the like, and a scanner operation is started.

In the original paper transport unit 2, when an original is placed in the original placement tray 2a, this original is drawn out from the tray 2a, and transported. The image reading unit 3 reads an image of the transported original, and outputs image data that expresses the original image to the image forming unit 5.

In the image forming unit 5, image data is temporarily saved in the memory 5a, and after compression, the image data is transferred to and saved on the hard disk apparatus 13. Then, the image forming unit 5, at the timing of image data sending by the interface 12, reads the image data from the hard disk apparatus 13, decompresses that data, and outputs the data to the interface 12.

The interface 12, via the image forming unit 5, inputs the image data from the hard disk apparatus 13, and via the LAN 23 or the Internet 24, sends the image data to the external terminal apparatus 25.

Document Filing Function

In the image forming apparatus 1, it is possible to save, to the hard disk apparatus 13 or an external terminal apparatus 22, image data read with the image reading unit 3 or image data received by network communications or facsimile communications, and read that image data as necessary to perform printing, sending, or saving.

Next is a detailed description of the operation unit 4 of the image forming apparatus 1.

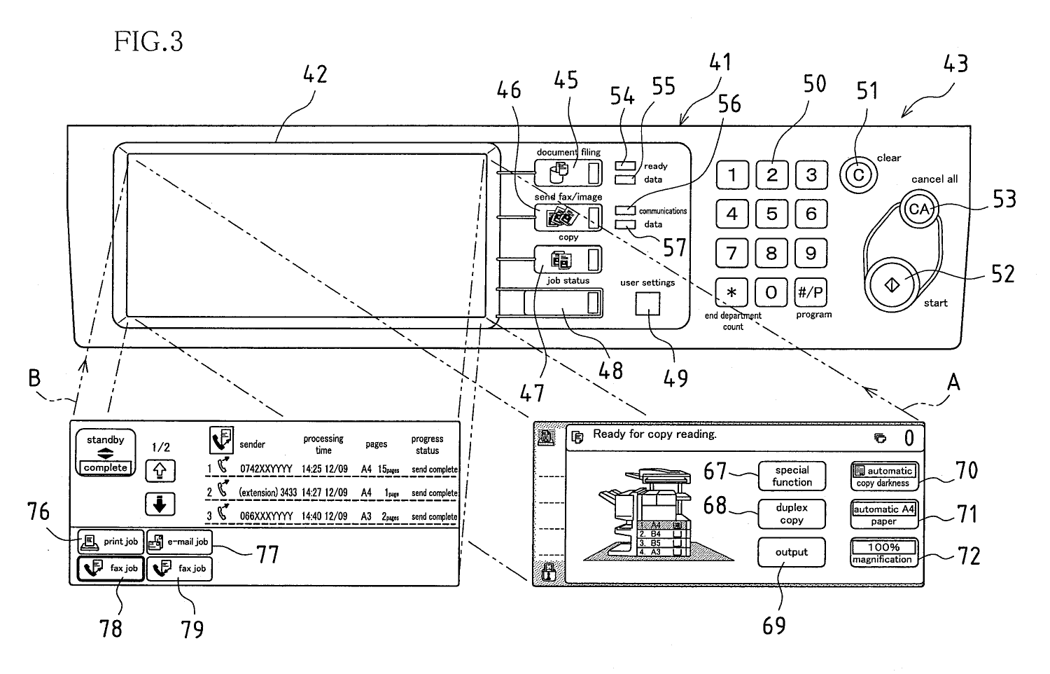

The operation unit 4, as shown in FIG. 1, is provided in a front side wall of the image reading unit 3, and includes a long narrow operation panel 41 left to right on the upper face thereof. As shown in FIG. 3, a liquid crystal touch panel 42 is disposed in approximately the left half of the operation panel 41, and various operation keys 43 are disposed in approximately the right half of the operation panel 41.

The liquid crystal touch panel 42 has a rectangular shape that is long and narrow from left to right, and in the liquid crystal touch panel 42 a transparent touch panel having the same rectangular shape is overlaid on the screen of a liquid crystal display apparatus having the same rectangular shape. In the screen of the liquid crystal display apparatus, various illustrations, messages, display buttons, and the like are displayed. On the screen, when a user's finger touches a display button, the location of touching on the screen is detected by the touch panel, and a display button at this touch location is deemed to have been operated. Whatever type of display button is displayed at whatever position on the screen, if the touch position on the screen detected by the touch panel matches the position of a display button on the screen, this display button is deemed to have been operated.

With this liquid crystal display apparatus, when the screen is viewed from respective directions A and B that differ from each other as shown in FIG. 1, it is possible to view respective display contents that differ from each other. Accordingly, when two users are standing at the front left and front right of the image forming apparatus 1, it is possible for the user on the left and the user on the right to view respective display contents that differ from each other. This sort of liquid crystal display apparatus is called a dual view liquid crystal display apparatus.

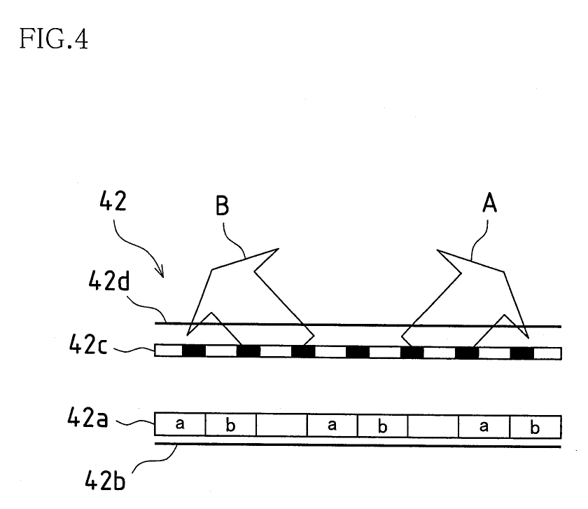

In the liquid crystal touch panel 42, as shown in FIG. 4, a backlight 42b is disposed on the back face side of a liquid crystal display panel (such as a TFT liquid crystal display panel) 42a, a parallax barrier (optical separation element) 42c is disposed on the front face side of the liquid crystal display panel 42a, and furthermore a transparent touch panel 42d is disposed overlaid on the parallax barrier 42c. The parallax barrier 42c is a screen having a plurality of perpendicular light-permeable slits that are separated by non-transparent regions.

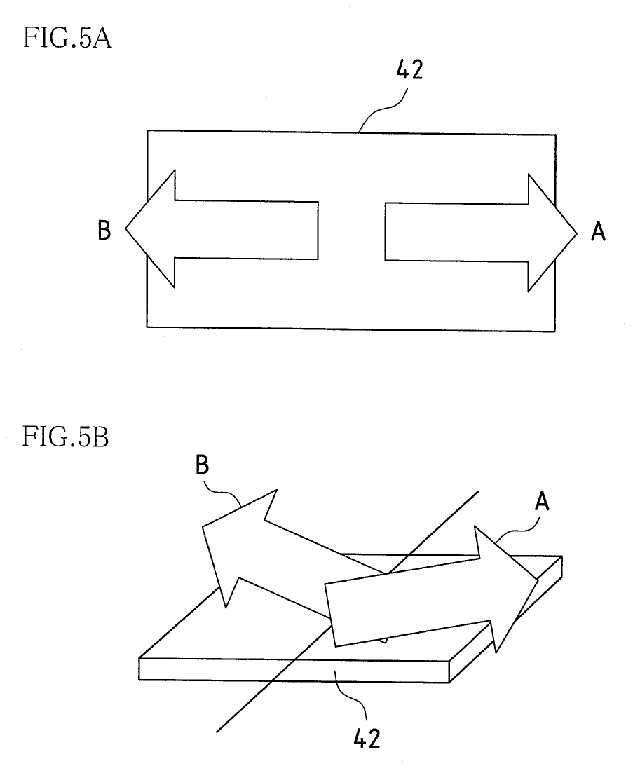

As shown in FIG. 4 and FIGS. 5A and 5B, light that has passed through pixels a of the liquid crystal display panel 42a, via the light-permeable slits of the parallax barrier 42c, arrives at the user on the left side positioned at a certain viewing field angle relative to the screen of the liquid crystal touch panel 42. Also, light that has passed through pixels b of the liquid crystal touch panel 42, via the light-permeable slits of the parallax barrier 42c, arrives at the user on the right side positioned at a separate certain viewing field angle relative to the screen of the liquid crystal touch panel 42. Accordingly, display contents that differ from each other and are displayed on the screen of the liquid crystal touch panel 42 can only be seen from respective regions that differ from each other and have been defined in space by the plurality of light-permeable slits of the parallax barrier 42c. Thus, on the screen, the two users on the left and right can simultaneously view display contents that differ from each other.

Also, with this liquid crystal touch panel 42, in a state in which a display button viewable by the user on the left side has been displayed on the screen, if the touch position on the screen detected by the touch panel 42d matches the position of the display button on the screen, this display button is deemed to have been operated. Likewise, in a state in which a display button viewable by the user on the right side has been displayed on the screen, if the touch position on the screen detected by the touch panel 42d matches the position of the display button, this display button is deemed to have been operated. Thus, it is possible that two users on the left and right, while simultaneously viewing on the screen display buttons that differ from each other, can touch a display button that the users respectively can see to operate the respective display buttons.

A display control unit (not shown) is connected to the liquid crystal display panel 42a, and display of the liquid crystal display panel 42a is controlled by this display control unit. The display control unit, according to an instruction or the like from the control unit 14, displays respective display contents (such as display buttons) that are viewable by the left and right users on the screen of the liquid crystal display panel 42a. Also, a touch position detection circuit is connected to the touch panel 42d. The detection circuit detects the touch position on the touch panel 42d, and notifies the control unit 14 of the detected touch position. The control unit 14 is aware of a display area of display buttons on the screen, and when the detected touch position on the touch panel 42d is within the display area of a display button, determines that display button to have been operated.

Below are separate descriptions of the screen of the liquid crystal touch panel when viewed from direction B by the user on the left side, and the screen of the liquid crystal touch panel when viewed from direction A by the user on the right side.

On the other hand, as shown in FIG. 3, the operation keys 43 are disposed on the right side of the liquid crystal touch panel 42 in the operation panel 41. The operation keys 43 include, for example, mode selection keys 45 to 47, a job status key 48, a user settings key 49, a numeric keypad 50, a clear key 51, a start key 52, and a cancel all key 53.

The mode selection keys 45 to 47 are keys that switch the display mode of the liquid crystal touch panel 42. For example, when the key 45 that designates the printer function is pressed, display contents for using the printer function are displayed on the screen of the liquid crystal touch panel 42 when viewed by the user on the right side.

When the key 46 that designates facsimile/image sending is pressed, display contents for using the facsimile function or the scanner function are displayed on the screen of the liquid crystal touch panel 42 when viewed by the user on the right side.

When the key 47 that designates copying is pressed, display contents for using the copy function are displayed on the screen of the liquid crystal touch panel 42 when viewed by the user on the right side.

Accordingly, when using the printer function, the facsimile function, or the scanner function, the display contents for using that function are displayed on the screen of the liquid crystal touch panel 42 when viewed by the user on the right side.

When the key 48 that designates job status is pressed, display contents that show the status of present jobs are displayed on the screen of the liquid crystal touch panel 42 when viewed by the user on the left side. Examples of this job status include the results of sending/receiving a facsimile, the results of sending scanned image data to an external terminal apparatus 25, and the status of receiving and printing image data from an external terminal apparatus 25.

Accordingly, the status of various types of jobs is displayed on the screen of the liquid crystal touch panel 42 when viewed by the user on the left side.

The user settings key 49 is operated when setting a folder for saving image data in the hard disk apparatus 13 or an external terminal apparatus 25, or when setting an environment when using the printer function. The numeric keypad 50 includes numeric keys from 0 to 9, and is operated when, for example, inputting a destination phone number when sending a facsimile, or when inputting a necessary number of copies when copying.

The clear key 51 is operated when, for example, deleting a numeric value that has been input from the numeric keypad 50. The start key 52 is operated when instructing to, for example, start copying when the copy function has been set, start reading of an original image when the scanner function has been set, or start reading of an original image when the facsimile function has been set. The cancel all key 53 is operated when canceling various settings during operation, or when starting operation from the initial state.

Furthermore, the operation panel 41 is provided with a ready lamp 54 that informs whether or not image data can be received from an external terminal apparatus, a data lamp 55 that informs that image data is being received or being printed, a communications lamp 56 that informs that a facsimile is being sent or received, and a data lamp 57 that informs that image data is being sent to an external terminal apparatus.

This sort of operation unit 4 is provided with a dual view liquid crystal display apparatus, as stated above. Thus, it is possible that two users on the left and right, while simultaneously viewing on the screen respective display contents (such as display buttons) that differ from each other, can, for example, operate a display button that each user can see. For example, display buttons for using the printer function, the facsimile function, or the scanner function, are displayed on the screen of the liquid crystal touch panel 42 when viewed by the user on the right side, and buttons related to the status of present jobs are displayed on the screen of the liquid crystal touch panel 42 when viewed by the user on the left side, so it is possible for the user on the right side to operate the display buttons on the screen for using those functions, and possible for the user on the left side to simultaneously operate the display buttons on the screen related to the status of present jobs.

Display buttons when viewed by the user on the right side are displayed on the right side half of the screen of the liquid crystal touch panel 42, and display buttons when viewed by the user on the left side are displayed on the left side half of the screen of the liquid crystal touch panel 42. As stated above, operation keys are disposed on the right side of the liquid crystal touch panel 42 in the operation panel 41, so display buttons in the right side half of the screen of the liquid crystal touch panel 42 and the operation keys on the right side of the liquid crystal touch panel 42 are disposed near the front of the user on the right side. Therefore, while the user on the right side is operating display buttons for using the various functions on the right side half of the screen, the operation keys on the right side of the liquid crystal touch panel 42 can also be easily operated, and there is no interference with operation of the user on the left side.

Also, the user on the left side can operate display buttons related to the status of present jobs in the left side half of the screen. Further, with respect to operation of display buttons related to the status of present jobs, it is almost not necessary to operate the operation keys on the right side of the liquid crystal touch panel 42, so there is almost no interference with operation of the user on the right side.

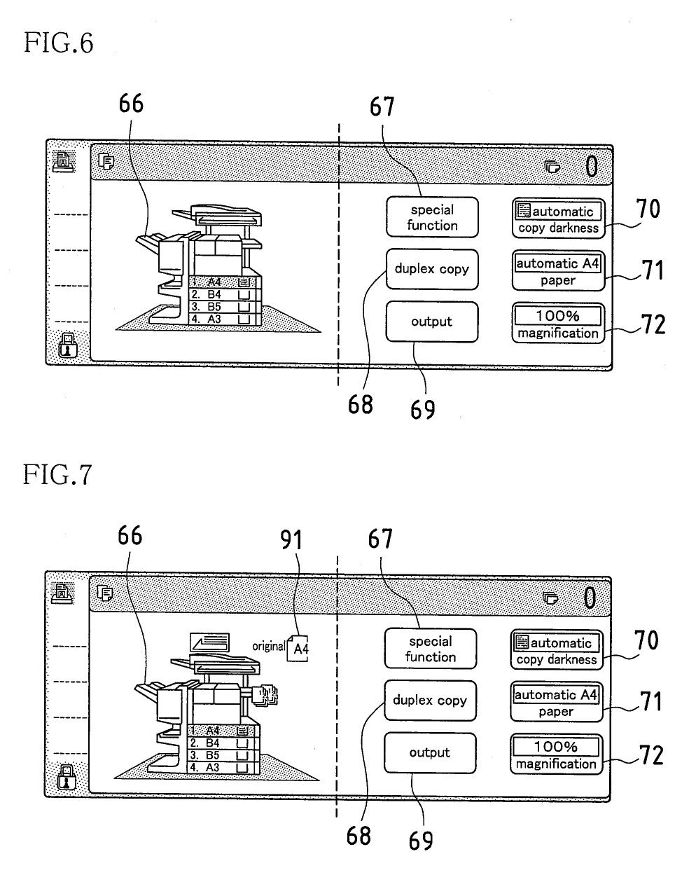

Next is a description of display examples of the screen of the liquid crystal touch panel 42 when viewed by the user on the right side, with reference to FIGS. 6 to 14. Note that in FIGS. 6 to 14, the broken line in the center indicates a center line of the liquid crystal touch panel 42, but this line is not actually displayed. Also, the display contents of the liquid crystal touch panel 42 are determined by the control unit 14 according to an input operation or the like of the operation unit 4, and the control unit 14 instructs the display control unit of the liquid crystal touch panel 42.

Here, because these are display examples of the screen of the liquid crystal touch panel 42 when viewed by the user on the right side, in each of the display examples shown in FIGS. 6 to 14, display buttons are displayed in the right side half of the screen, and the display buttons are disposed near the operation keys on the right side of the liquid crystal touch panel 42.

FIG. 6 shows an initial screen of the liquid crystal touch panel 42 when the mode selection key 47 of the operation panel 41 has been pressed. As shown in FIG. 6, on the left side of the screen, an illustration 66 of the image forming apparatus 1 that reflects the state of each paper feed cassette 6a is displayed, and on the right side of the screen, display buttons 67 to 72 for designating “special function”, “duplex copy”, “output”, “copy darkness”, “paper”, and “magnification” are displayed.

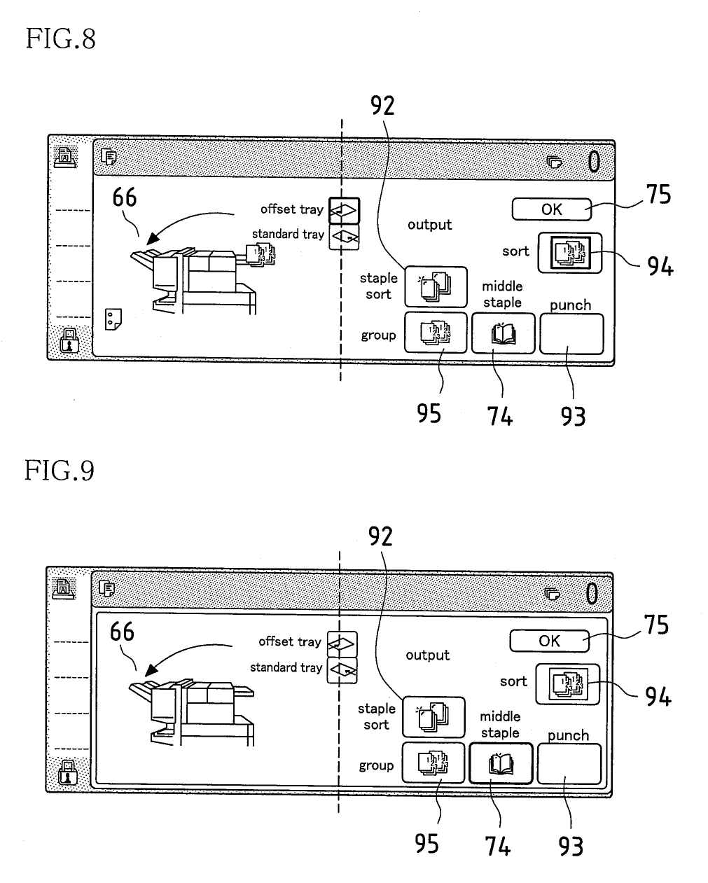

In this state, when for example an A4-size original is placed in the original placement tray 2a of the original paper transport unit 2, the presence and size of the original is detected by the original detection sensor 3a, and as shown in FIG. 7, an icon 91 that indicates “original A4” is displayed on the left side of the screen of the liquid crystal touch panel 42. In this state, if the display button 69 for designating “output” is touched by a user's finger and thus operated, the display of the liquid crystal touch panel 42 transitions as shown in FIG. 8.

In the screen shown in FIG. 8, a “middle staple” display button 74 and a “staple sort” display button 92 for binding a copied print, a “punch” display button 93 for forming holes in a copied print, and a “sort” display button 94 for sorting in units of copies and a “group” display button 95 for sorting in units of pages when copying originals of a plurality of pages, are displayed.

Accordingly, in the screen shown in FIG. 8, it is possible to designate stapling or hole forming, a method of output to a discharge tray when printing a plurality of copies, and the like. In this screen, if for example the “middle staple” display button 74 is touched by a user's finger and thus operated, the color scheme of the display button 74 is displayed in reverse, and the screen transitions to the screen shown in FIG. 9. Then, when an “OK” display button 75 in the screen in FIG. 9 is operated, returning to the screen in FIG. 6, and then the start key on the right side of the liquid crystal touch panel 42 is operated, a copy operation that includes “middle staple” processing is performed. Note that also while the screen in FIG. 9 is displayed, if the start key 52 on the right side of the liquid crystal touch panel 42 is operated, likewise a copy operation that includes “middle staple” processing is performed.

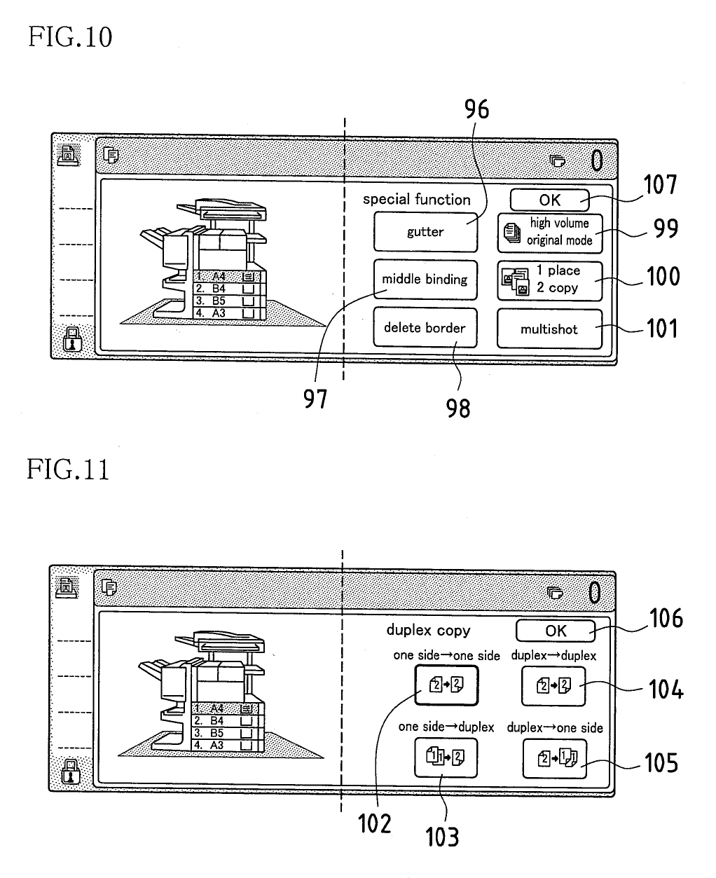

Also, in the screen in FIG. 6, when the “special function” display button 67 is operated, the screen transitions to the screen in FIG. 10, and on this screen also it is possible to set various functions.

Specifically, displayed in the screen in FIG. 10 are a “gutter” display button 96 for creating a gutter in the printed recording paper, a “middle binding” display button 97 for making the printed recording paper into a middle-bound brochure by folding in the center into two parts, a “delete border” display button 98 for eliminating a shaded border produced when copying a book or the like, a “high volume original mode display button” 99 for reading and copying an original of a number of pages that cannot be fed at once by the original paper transport unit 2 by dividing the original, a “1 place 2 copy” display button 100 for consecutively copying in order the left and right halves of an original, a “multishot” display button 101 for copying an original of a plurality of pages uniformly allocated to one sheet of recording paper, and an “OK” display button 107 for returning to the screen in FIG. 6.

When a display button in the screen in FIG. 10 is selectively designated, and the start key 52 on the right side of the liquid crystal touch panel 42 is operated, a copy operation that includes processing designated by this display button is performed.

Alternatively, when a “duplex copy” display button 68 in the screen in FIG. 6 is operated, the screen transitions to the screen in FIG. 11, and duplex copying can be set.

Specifically, displayed in the screen in FIG. 11 are a “one side→one side” display button 102 operated when copying one side of an original to only one side of recording paper, a “one side→duplex” display button 103 operated when sequentially copying one side of each original to both sides of recording paper, a “duplex→duplex” display button 104 operated when copying both sides of an original to both sides of recording paper, a “duplex→one side” display button 105 operated when respectively copying both sides of an original to one side of recording paper, and an “OK” display button 106 for returning to the screen in FIG. 6.

When a display button in the screen in FIG. 11 is selectively designated and the start key 52 on the right side of the liquid crystal touch panel 42 is operated, a copy operation that includes processing designated by this display button is performed.

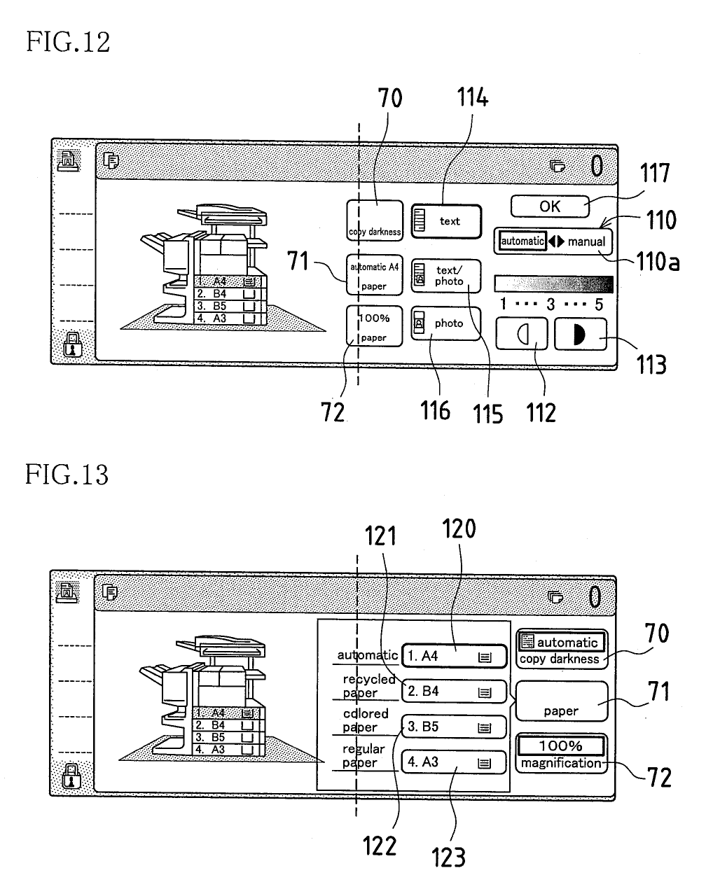

Further, when a “copy darkness” display button 70 in the screen in FIG. 6 is operated, the screen transitions to the screen in FIG. 12, and other than the darkness setting, it is possible to set an original type.

Specifically, displayed in the screen in FIG. 12 is an “automatic/manual” display button 110 for determining the darkness automatically or manually, and when operated by a user's finger touching a manual side 110a of the display button 110, by a following operation of darkness adjustment buttons 112 and 113 it is possible to lighten or darken the copy darkness. Also displayed are a “text” display button 114 operated when the original contains only text information, a “text/photo” display button 115 operated when the original includes both text and photographic images, and a “photo” display button 116 operated when the original is a photograph. By selecting a mode corresponding to the original with the display buttons 114, 115, and 116, reading processing appropriate for the original is performed. Also, when an “OK” display button 117 is pressed, the screen returns to the screen in FIG. 6.

When the “paper” display button 71 is pressed in the screen in FIG. 6, the screen transitions to the screen in FIG. 13, and it is possible to select recording paper.

Specifically, displayed in the screen in FIG. 13 are a display button 120 for designating “A4” as the paper size of the recording paper, a display button 121 for designating “B4”, a display button 122 for designating “B5”, and a display button 123 for designating “A3”, so that it is possible to select the paper size of the recording paper.

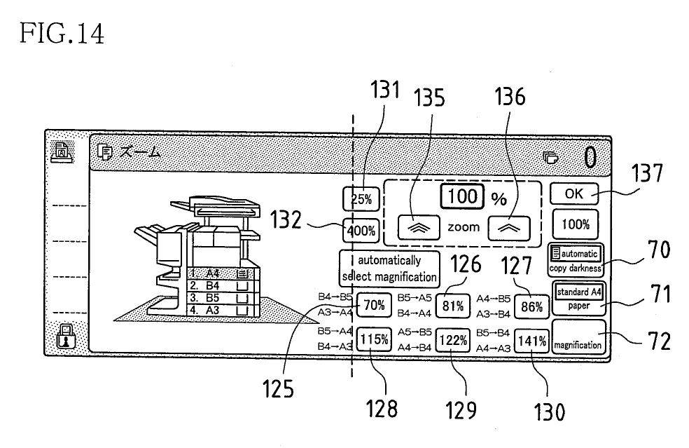

Further, when the “magnification” display button 72 is pressed in the screen in FIG. 6, the screen transitions to the screen in FIG. 14, and it is possible to set enlargement or reduction, or a paper designated zoom factor.

Specifically, displayed in the screen in FIG. 14 are display buttons 125 to 132 for designating enlargement or reduction at a fixed magnification ratio. For example, when the display button 127 is operated when copying an A4-size original to B5-size recording paper, the original image is automatically reduced to 86%. Also displayed are zoom buttons 135 and 136 for manually determining a magnification ratio. The magnification ratio can be decreased by operating the button 135 and increased by operating the button 136. Also, when an “OK” display button 137 is pressed, the screen returns to the screen in FIG. 6.

When selecting various processing for copying in this manner, various display buttons are displayed on the right side half of the screen of the liquid crystal touch panel 42 when viewed by the user on the right side, and these display buttons are disposed near the operation keys on the right side of the liquid crystal touch panel 42. Therefore, while viewing the screen of the liquid crystal touch panel 42, the user on the right side can easily operate the display buttons and the operation keys to select and set various processing.

Also, information of illustrations or the like are displayed are displayed on the left side half of the screen of the liquid crystal touch panel 42 when viewed by the user on the right side, so operability improves.

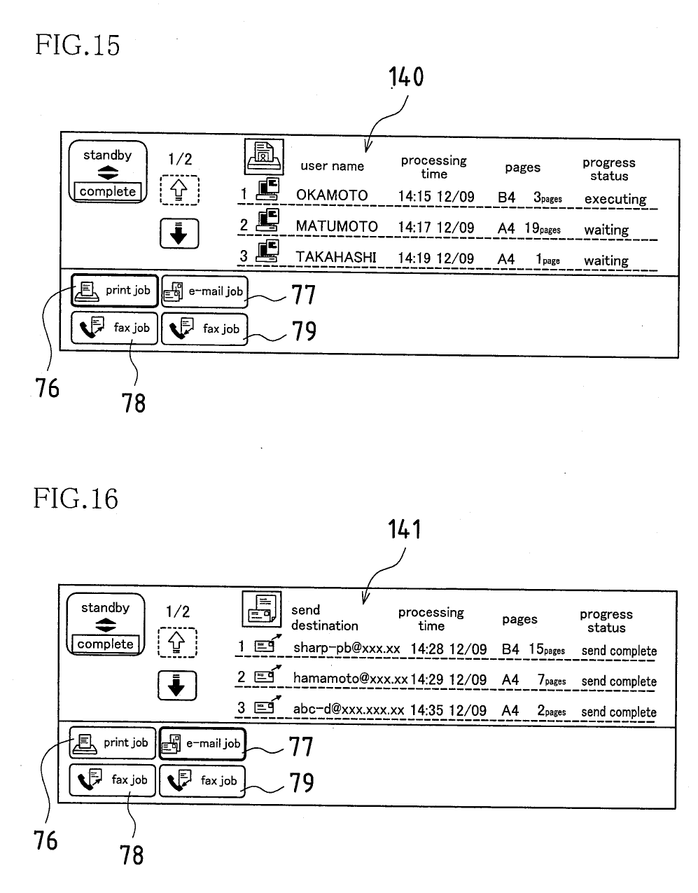

Next is a description of display examples of the screen of the liquid crystal touch panel 42 when viewed by the user on the left side, with reference to FIGS. 15 to 20. Note that the display contents of the liquid crystal touch panel 42 are determined by the control unit 14 according to an input operation or the like of the operation unit 4, and the control unit 14 instructs the display control unit of the liquid crystal touch panel 42.

Here, because these are display examples of the screen of the liquid crystal touch panel 42 when viewed by the user on the left side, in each of the display examples shown in FIGS. 15 to 20, display buttons are displayed in the left side half of the screen. Accordingly, the operation keys on the right side of the liquid crystal touch panel 42 are separated from the display buttons, but because the frequency of operation of the numeric keypad 50, the start key 52, and the like is low, there is little effect on usability.

FIG. 15 shows an initial screen of the liquid crystal touch panel 42 when viewed by the user on the left side. This initial screen may always be displayed, or it may be displayed first when a specific key (for example, the job status key 48) of the operation panel 41 has been pressed. In this case, in an ordinary situation in which only one user is using the liquid crystal touch panel 42, same as in an ordinary liquid crystal touch panel, it is possible to display the same screen whether viewed from the left or from the right. A configuration is adopted in which when two users on the left and the right are using the liquid crystal touch panel 42, in response to operation of the specific key, it is possible for the left and right users to view respective display contents that differ from each other on the screen.

Displayed in the lower left of this screen are buttons 76 to 79 labeled “print job”, “e-mail job”, “(send) facsimile job”, and “(receive) facsimile job”, and by selectively operating the buttons 76 to 79, it is possible to transition to any of the screens in FIGS. 15 to 18.

In the screen in FIG. 15, the “print job” display button 76 has already been selected and operated, resulting in a job status screen 140. In this screen 140, it is possible to confirm the progress status of the printer mode. That is, the progress status of print processing that has been ordered from an external terminal apparatus 25 is displayed.

The screen in FIG. 16 is a job status screen 141 shown when the “e-mail job” operation button 77 has been selected and operated. This screen 141 displays the progress status when image data acquired from the image reading unit 3 is attached to electronic mail, and this electronic mail is sent directly from the image forming apparatus 1 to an external terminal apparatus 25.

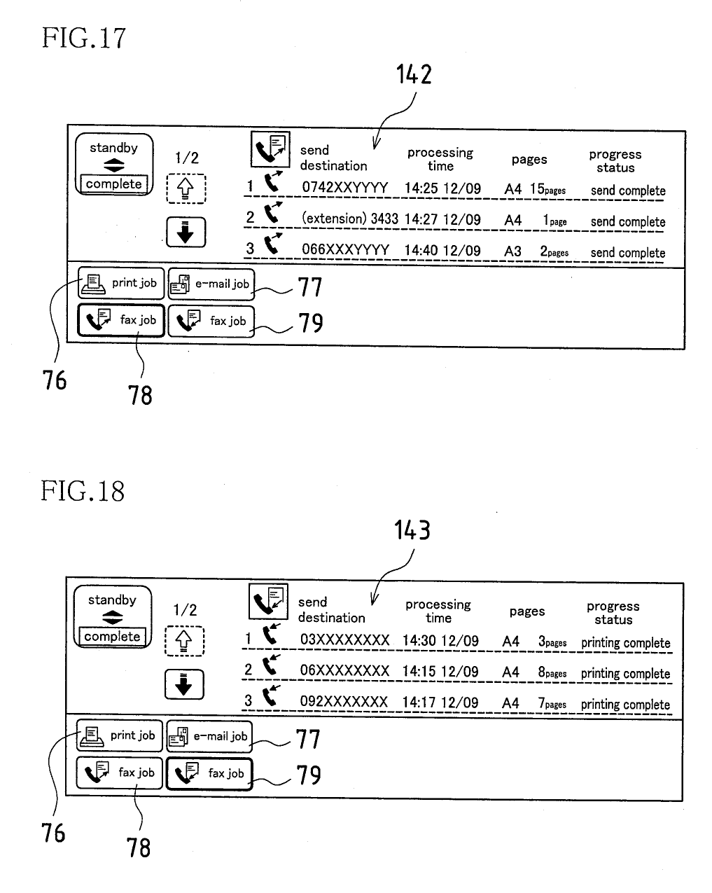

The screen in FIG. 17 is a job status screen 142 shown when the “(send) facsimile job” operation button 78 has been selected and operated. In this screen 142, it is possible to confirm the progress status of processing to send a facsimile to an external terminal apparatus 22. The screen in FIG. 18 is a job status screen 143 shown when the “(receive) facsimile job” operation button 79 has been selected and operated. In this screen 143, it is possible to confirm the progress status of processing to receive a facsimile from an external terminal apparatus 22.

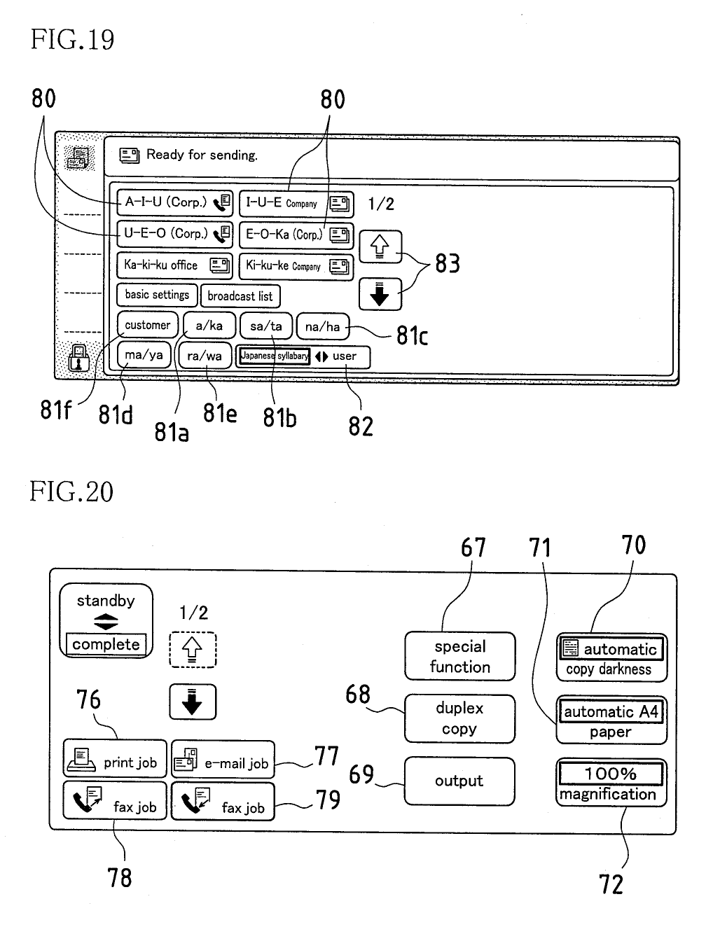

Here, for example in the case of the screen in FIG. 17, when the key 46 that designates facsimile/image sending on the right side of the liquid crystal touch panel 42 is pressed, the screen transitions to the screen in FIG. 19, and by operation in this screen, it is possible to perform processing to send image data saved on the hard disk apparatus 13 or the like to an external terminal apparatus 22, 25, or the like.

Displayed in the screen in FIG. 19 is a send destination address book in which facsimile numbers or electronic mail addresses have been registered in advance. Specifically, display buttons 80 that indicate a name or title of a send destination are displayed in a region on the left side of the screen. Here, an “a/ka” display button 81a has already been operated, so send destinations starting with an “a/ka” line are displayed, but by selectively operating a “sa/ta” display button 81b, a “na/ha” display button 81c, a “ma/ya” display button 81d, a “ra/wa” display button 81e, a “customer” display button 81f, or the like, it is possible to display other send destinations. Also, the send destinations are displayed in “Japanese syllabary” order, but if a “user” display button 82 is pressed, it is possible to display an address book registered for each user. A “½” display indicates that the screen spans two pages, and it is possible to transition between the two pages by operating arrow buttons 83.

In the screen in FIG. 19, when designating a send destination, it is possible to select a send file in the next screen (not shown), and by pressing a “send” button displayed in that next screen, it is possible to send designated image data to a designated send destination.

When confirming job status in this manner, the job status is displayed on the screen of the liquid crystal touch panel 42 when viewed by the user on the left side, and the various display buttons are displayed in the left side half of the screen. Therefore, while viewing the screen of the liquid crystal touch panel 42, the user on the left side can easily operate the display buttons to confirm the various types of job status.

Next is a description of the positional relationship of respective display buttons that differ from each other and are viewed by the left and right users, in screens of the liquid crystal touch panel 42.

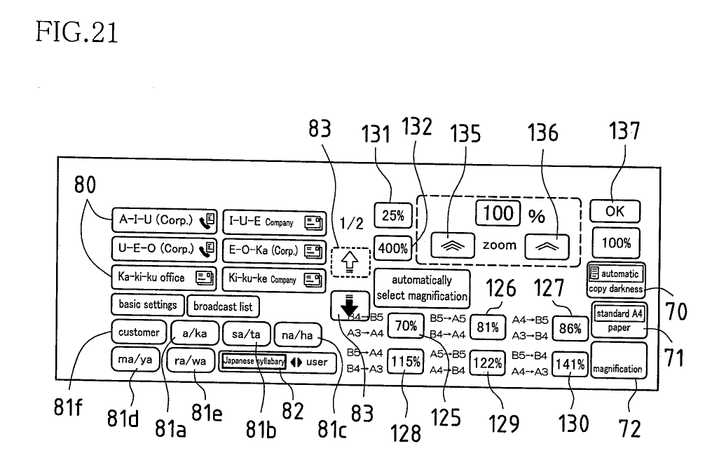

FIG. 20 shows display buttons of the right side half of the screen in FIG. 6 viewed by the right side user, and display buttons of the left side half of the screen in FIG. 18 viewed by the left side user, disposed on the screen. FIG. 21 shows display buttons of the right side half of the screen in FIG. 14 viewed by the right side user, and display buttons of the left side half of the screen in FIG. 19 viewed by the left side user, disposed on the screen.

As is clear from these diagrams, respective screens that differ from each other are displayed to the left and right users, and even when those screens change, there is never any overlapping of the display positions of the respective display buttons operated by the left and right users. Accordingly, when some display button has been operated, the touch panel reliably detects the position of the display button, and so it is possible to change the screen display and control the image forming apparatus in response to the display button operation.

Also, because the key 45 that designates the printer function, the key 46 that designates facsimile/image sending, and the key 47 that designates copying are disposed on the right side of the liquid crystal touch panel, and the “copy darkness” display button 70, the “paper” display button 71, and the “magnification” display button 72 are displayed on the right side half of the screen of the liquid crystal touch panel 42, operation keys and display buttons that are operated in connection with each other are disposed close together, improving operability.

Note that the present invention is not limited by the above embodiment; appropriate modifications are possible. For example, the screen configuration can be appropriately modified, as long as respective display buttons that differ from each other and are viewed by left and right users are displayed on the screen such that the respective display buttons do not overlap, using a “dual view liquid crystal”. Also, in the above embodiment, an example was described in which the present invention was applied to the image forming apparatus 1, but the invention is also applicable to various types of devices other than image forming apparatuses. For example, the invention may be applied to the operation panel of a machine tool or the like, so that while one user is using a liquid crystal touch panel or operation keys to set or operate the machine tool, another user can confirm the status of the machine tool.

Also, in the above embodiment, the operation keys are disposed on the right side of the liquid crystal touch panel 42, but the operation keys may also be disposed in a different location, for example on the left side of the liquid crystal touch panel 42. Further, operation keys may be disposed on each of both the left and right sides of the liquid crystal touch panel 42. In this case, the left side operation keys are operated mainly by the user on the left side, and the right side operation keys are operated mainly by the user on the right side.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

What is claimed is:

1. An apparatus comprising a liquid crystal touch panel and operation keys, the liquid crystal touch panel displaying display buttons, and the operation keys being outside of the liquid crystal touch panel, and the display buttons of the liquid crystal touch panel and the operation keys being operated together,
wherein the liquid crystal touch panel, on a screen, displays display contents that differ from each other such that the display contents can be viewed from two directions that differ from each other, and
such that display buttons on the screen of the liquid crystal touch panel when viewed from one direction and operation keys used with the display buttons are near each other, the display buttons are disposed on the screen, or the operation keys are disposed relative to the liquid crystal touch panel.

2. The apparatus comprising a liquid crystal touch panel and operation keys according to claim 1,
wherein the display buttons are disposed on one side of the screen, such that display buttons on the screen of the liquid crystal touch panel when viewed from one direction and operation keys used with the display button are near each other, and display contents that differ from the display buttons are displayed on the other side of the screen.

3. The apparatus comprising a liquid crystal touch panel and operation keys according to claim 1,
wherein the apparatus comprising a liquid crystal touch panel and operation keys is applied to an image forming apparatus having a plurality of functions, and
the display buttons are disposed in one half of the screen, such that display buttons on the screen of the liquid crystal touch panel when viewed from one direction and operation keys used with the display buttons are near each other,
other display buttons are disposed in the other half of the screen of the liquid crystal touch panel when viewed from the other direction, and
the display buttons in the one half and the other display buttons in the other half of the screen of the liquid crystal touch panel are related to functions that differ from each other.
